(19) United States
(12) Patent Application Publication
(10) Pub. No.: US 2015/0183164 A1
(43) Pub. Date: Jul. 2, 2015

(54) RAPID ELECTRO-MAGNETIC HEATING OF NOZZLE IN POLYMER EXTRUSION BASED DEPOSITION FOR ADDITIVE MANUFACTURING

(71) Applicants: Chad E. DUTY, Loudon, TN (US); Vlastimil KUNC, Concord, TN (US); Lonnie J. LOVE, Knoxville, TN (US); Orlando RIOS, Knoxville, TN (US)

(72) Inventors: Chad E. DUTY, Loudon, TN (US); Vlastimil KUNC, Concord, TN (US); Lonnie J. LOVE, Knoxville, TN (US); Orlando RIOS, Knoxville, TN (US)

(21) Appl. No.: 14/143,934

(22) Filed: Dec. 30, 2013

(51) Int. Cl. B29C 67/00; B29C 35/08

(52) U.S. Cl. CPC B29C 67/0062; B29C 67/0085; B29C 35/0805; B29K 2905/00; B29K 2909/02; B29K 2101/00

(57) ABSTRACT

A method and apparatus for additive manufacturing that includes a nozzle for extruding a plastic material and a supply of polymeric working material provided to the nozzle, wherein the polymeric working material is magnetically susceptible and/or electrically conductive. A magneto-dynamic heater is provided for producing a time varying, high flux, frequency sweeping, alternating magnetic field in the vicinity of the nozzle to penetrate into and couple the working material to heat the material through at least one of an induced transient magnetic domain and an induced, annular current.

### GOVERNMENT RIGHTS

This invention was made with government support under Contract No. DE-AC05-00OR22725 awarded by the U.S. Department of Energy. The government has certain rights in the invention.

### FIELD OF THE INVENTION

The present invention relates to a rapid non-contact energy transfer for additive manufacturing driven high intensity electromagnetic fields.

### BACKGROUND OF THE INVENTION

Additive manufacturing may be used to quickly and efficiently manufacture complex three-dimensional components layer-by-layer, effectively forming complex components. Such additive manufacturing may be accomplished using polymers, alloys, powders, wires, or similar feed stock materials that transition from a liquid or granular state to a cured, solid component.

Polymer-based additive manufacturing is presently accomplished by several technologies that rely on feeding polymer materials through a nozzle that is precisely located over a preheated polymer substrate. Parts are manufactured by the deposition of new layers of materials above the previously deposited layers. Unlike rapid prototyping processes, additive manufacturing is intended to produce a functional component constructed with materials that have strength and properties relevant to engineering applications. On the contrary, rapid prototyping processes typically produce exemplary models that are not production ready.

Heating of the feed or filler material in the nozzle in additive manufacturing is generally accomplished by direct contact between a polymer feed stock and a heating element, typically a resistively heated metal cylinder at elevated temperatures. Likewise, in additive manufacturing, unlike rapid prototyping, the entire component under construction is typically maintained at an elevated temperature in a chamber or furnace until the build is complete. Keeping previously deposited layers at elevated temperature improves the adhesion between the component and newly deposited material while minimizing macroscopic distortion. There are inherent limitations to this technology that prevent higher deposition rates, out of furnace printing and control of microstructural defects (such as pores).

In addition, existing additive manufacturing processes, including polymer extrusion based deposition for additive manufacturing (PeD), typically exhibit a thermal lag associated with heating a deposition nozzle. Typical PeD systems obtain thermal stability by maintaining a massive resistive heater at a constant temperature resulting in slow response. This makes accurate control of the flow control difficult and prevents the building of advanced structures that require transient deposition rates and frequent interruptions in flow (in a mechanism analogous to image generation in an ink jet printer).

Magneto-thermal conversion is the conversion of electromagnetic energy into thermal energy. In ferromagnetic magnetic materials, a principle mechanism underlying magneto-thermal conversion is related to externally induced disturbances in the magnetic structure and how strongly the materials resist these disturbances. The dissipated electromagnetic energy is the product of these two and can be transformed into thermal energy among other forms. Therefore the external field should be sufficient to induce disturbances in the magnetic structure while the magnetic material should provide sufficient resistance to dissipate energy yet not resist so strongly that the external fields cannot induce disturbances. It is therefore desired to match the magnetic response of a material with the correct amplitude and frequency of electromagnetic energy. In soft magnetic materials, there is a minimal energetic barrier to either rotate the moment within a domain, or nucleate a reversed domain and move the resulting domain as opposed to hard magnetic materials that resist such disturbances. The energy product associated with magnetic materials is a function of the coercivity, remnant magnetization and magnetic anisotropy. In general, materials with coercivity ≧1000 Oe can be classified as hard ferromagnets. Soft ferromagnets have lower coercivity, and good soft ferromagnets have coercivity <1 Oe. Intermediate materials having a coercivity >1 Oe and <1000 Oe are useful in applications where a magnetic hysteresis losses are required in applications such as, for example, transformation of electromagnetic energy into thermal energy, also known as magneto-thermal conversion

### SUMMARY OF THE INVENTION

One motivation for the subject invention is to increase the sensitivity and controllability of the flow of polymer, both of which translate to increased build rates. This is accomplished, in part, by reducing the weight of the liquefier and increasing the thermal response time between the power supply and liquefier. The subject invention enables high fidelity control of deposition rates with a non-contact heating technology that can be used to quickly heat a low thermal mass deposition nozzle, materials within a deposition nozzle, locally heat specific locations of the build and/or uniformly heat the build out of the furnace.

In addition, removal of joule heating will significantly separate the position dependent heat source from the extruder which impacts part quality. In this manner, a part may be manufactured in accordance with the invention in large scale applications and without reliance on an oven or controlled environment for the build. Further, this technology may be used as a means to apply targeted heating of the polymer material through the build or locally to active manufacturing surface locations. This is accomplished by applying high intensity electromagnetic energy, for instance, transient high flux alternating magnetic fields, to the previous layers polymer materials.

Further, the polymer feed materials may be tuned by doping the polymer feed stock with specific magnetically active materials, microscale particles, and/or nano particles. As a result, custom feed materials may be employed depending on the desired characteristics of the build, for instance, carbon fiber may be added to the feed material to tailor conductive properties and thus rapidly and uniformly heat the feed material, when desired.

Other objects and advantages will be apparent to those skilled in the art from the following detailed description taken in conjunction with the appended claims and drawings.

### BRIEF DESCRIPTION OF THE DRAWINGS

FIG. 1 is a schematic of a system according to one embodiment of this invention.

FIG. 2 is a side view of a nozzle according to one embodiment of this invention.

FIG. 3 is a schematic of a nozzle and heater according to one embodiment of this invention.

FIG. 4 is a schematic representation of an induced circular current resulting in an opposing magnetic field as generated by the system according to one embodiment of this invention.

FIG. 5A shows a graph of magnetic response of a soft magnetic test material that can be used to produce enhanced magneto-dynamic heating.

FIG. 5B shows a graph of magnetic response of an intermediate magnetic test material that can be used to produce enhanced magneto-dynamic heating.

FIG. 5C shows a graph of magnetic response of a hard magnetic test material that can be used to produce enhanced magneto-dynamic heating.

FIG. 6A is a graph demonstrating application of the system according to one embodiment of this invention.

FIG. 6B is a graph demonstrating application of the system according to one embodiment of this invention.

FIG. 6C is a graph demonstrating application of the system according to one embodiment of this invention.

FIG. 6D is a graph demonstrating application of the system according to one embodiment of this invention.

FIG. 7 is a graph showing data for heating a polymer matrix doped with iron oxide (Fe₂O₃) according to one embodiment of this invention.

FIG. 8 is a graph showing data for heating a polymer matrix doped with manganese borate (MnB) according to one embodiment of this invention.

FIG. 9 is a graph showing data for heating a polymer matrix doped with nano particles according to one embodiment of this invention.

FIG. 10 is a graph showing data for heating a polymer matrix doped with carbon fiber according to one embodiment of this invention.

### DETAILED DESCRIPTION OF THE INVENTION

The present invention provides a non-contact heating technology that can be used to quickly heat materials within a deposition nozzle, locally heat specific locations of a deposition modeling build and/or uniformly heat the build outside of a furnace or similarly controlled environment. As a result, the weight and size of the liquefier is reduced and sensitivity and controllability of polymer flow is improved, resulting in increased build rates. According to a preferred embodiment, the subject method and apparatus employs high intensity electromagnetic energy, for instance, transient high flux alternating magnetic fields, to polymer working materials resulting in a highly controllable additive manufacturing process.

Although not required, the subject invention may be used in connection with large scale polymer added manufacturing such as the schematic shown in FIG. 1. FIG. 1 shows a frame or gantry 50 for containing a build. The gantry 50 preferably contains a deposition arm 60 that is moveable through the x, y and z-axis. The deposition arm 60 preferably accommodates a supply of working material and a deposition nozzle 80. The supply of working material may be onboard the deposition arm and/or remotely supplied from a hopper or similar storage vessel.

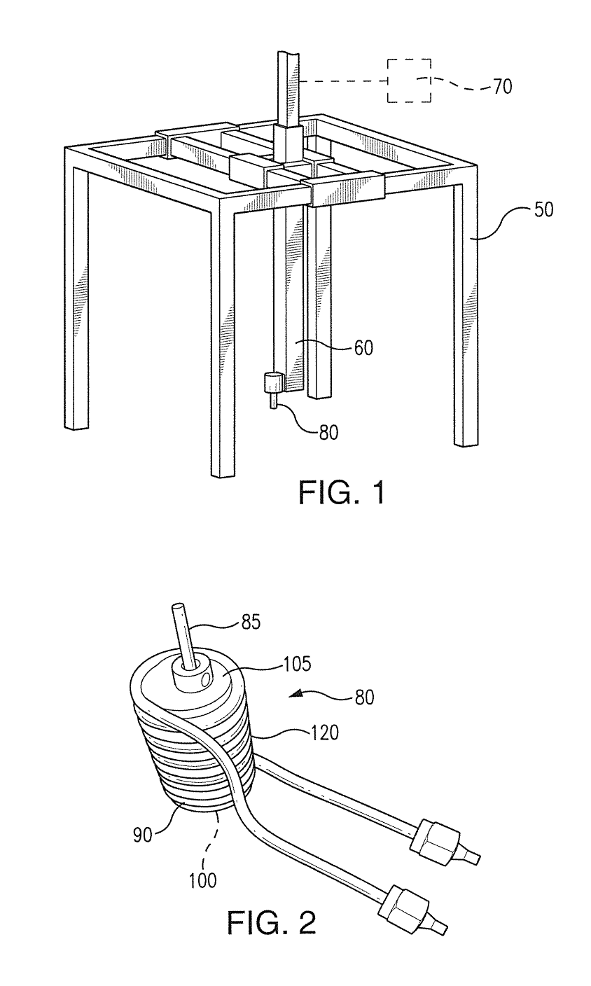

According to a preferred embodiment of the invention, a method of additive manufacturing includes the steps of providing an apparatus for additive manufacturing, for instance the gantry system shown in FIG. 1. The apparatus preferably includes a nozzle 80 for extruding a material, such as shown in FIG. 2. The nozzle 80 preferably operably contacts a polymeric working material that is magnetically susceptible and/or electrically conductive. FIG. 2 shows a preferred embodiment of the nozzle 80 including a barrel 85 through which the working material is provided, a plate 90 and a tip 100 from which the working material is directly deposited on the build. A coil 120 is preferably wrapped around the barrel and comprises an assembly that may further include a thermally conductive wrap 105 around the barrel 85, for instance, boron nitride.

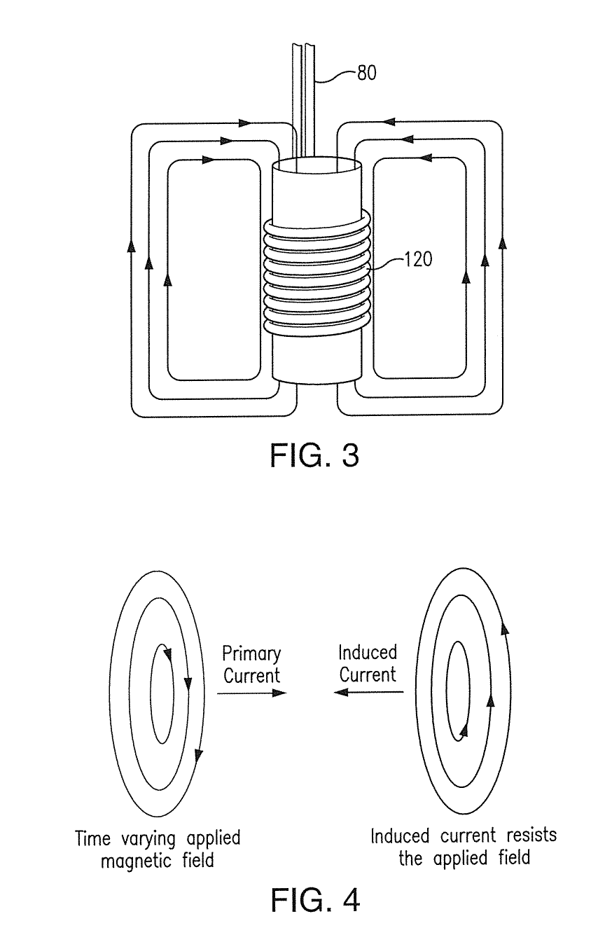

A schematic of a deposition nozzle 80 used in such a system is shown in FIG. 3. As shown in FIGS. 3 and 4, rapidly changing magnetic fields transfer energy to the working material matrix by two interrelated mechanisms. Transient magnetic fields penetrate into and are coupled by the magnetic properties of the matrix materials. This leads to an induced circular current that result in the generation of an opposing magnetic field as shown in FIG. 3. The induced current leads to direct electrical resistive heating of the material. Additionally, the external fields lead to generation of magnetically aligned domains that are reversed as the transient magnetic field is swept at high frequency.

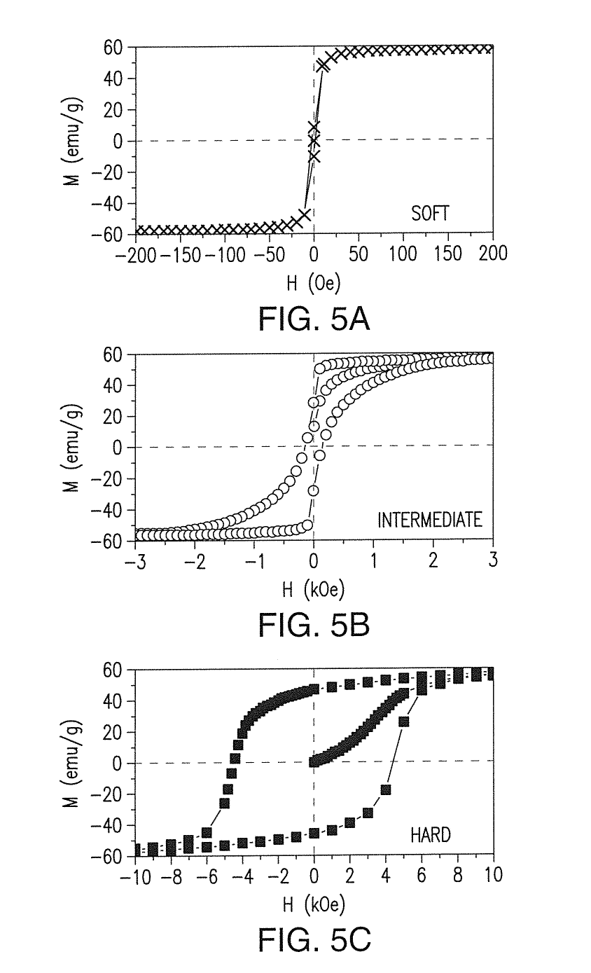

FIGS. 5A-5C show the test results from three examples of magnetic response of materials, for soft, intermediate and hard materials, respectively, that can be used to produce enhanced magneto-dynamic heating. By matching the magnetic response of the material with the electromagnetic wave dynamics, it is possible to tailor the depth of heat transfer enabling precise control of the location and efficiency of energy transfer to the polymer materials.

Accordingly, as shown in FIGS. 2 and 3, a printing nozzle 80 and tip 100 for use in PeD includes a metallic material guide or barrel 85 for permitting a desired flow of material wherein the tip 100 is positioned at an end of the material guide, or barrel 85, for depositing the material in an appropriate position in space. The printing nozzle 80 may further include a plate 90 at an end of the barrel 85 around the tip 100. The barrel 85 may be constructed of aluminum or similar metallic material having the desired properties. Alternatively, the barrel 85 may comprise a ceramic or similar non-electrically conductive material that is transparent to electromagnetic energy. This alternative arrangement permits direct heating of the working material from the coil 120.

FIG. 3 also shows an electro-magnetic heating element positioned with respect to the metallic barrel 85. According to a preferred embodiment of the invention, the electro-magnetic heating element comprises a coil 120 positioned around the barrel 85. As described above, a thermally conductive wrap 105 may be placed between the barrel 85 and the coil 120.

The coil 120 is preferably an induction heating coil wherein a desired number of turns of the coil 120 are used to introduce inductance into the nozzle 80 thereby producing a desired and controllable heating. Alternatively, a series of coils may be positioned around or with respect to the nozzle 80 to provide the desired heating. According to a preferred embodiment of this invention, the nozzle 80 is directly coupled to the power supply, i.e., the electro-magnetic energy source. The thermal link to the nozzle 80 may thus be quickly and controllably decoupled by decoupling the power supply from the nozzle 80. In this manner, heat control may be precisely administered to the nozzle 80.

The coil 120 may be insulated, for instance, with a TEFLON coating and is preferably tightly wrapped with respect to the barrel 85 or a conductive coating arranged around the barrel 85. According to one preferred embodiment of this invention, the coil 120 is arranged with non-uniform spacing. The printing tip 100 having non-uniform spacing may include an arrangement wherein the coil 120 is tighter at a distal end of the barrel 85.

According to one preferred embodiment, the electro-magnetic heating element, particularly the coil 120, is maintained at a lower temperature than material guide, or barrel 85. The printing nozzle 80 may further include a heat exchanger (not shown), primarily for cooling, positioned with respect to at least one of the tip 100 and the barrel 85 to provide a desired cooling to one or both respective components. In this manner, the deposition of material may be precisely controlled so as to avoid and excess or absence of material deposition in the desired locations. The heat exchanger may circulate at least one of helium and nitrogen to provide the desired cooling to the nozzle 80, more specifically to the tip 100 and/or the barrel 85 of the nozzle 80.

The nozzle 80 preferably produces a time varying, high flux, frequency sweeping, alternating magnetic field in the vicinity of the nozzle 80 so that (i) the time varying magnetic field penetrates into and is coupled by the magnetically susceptible working material to induce transient magnetic domains resulting in heating of the magnetically active components; and/or (ii) the transient magnetic field penetrates into and is coupled by the electrically conductive working material to generate an induced, annular current that causes direct electrical resistive heating of the material.

As described above, FIG. 3 shows a schematic of an electromagnetic apparatus according to one preferred embodiment of this invention. According to one embodiment, desired feed materials may be suspended in the apparatus within a coil, for example, water-cooled copper, and subjected to sinusoidal AC fields with a frequency of 180 kHz at several power settings. The feed material samples may be instrumented for surface and internal temperature measurements. The electromagnetic fields are then applied and the temperature was recorded as a function of time.

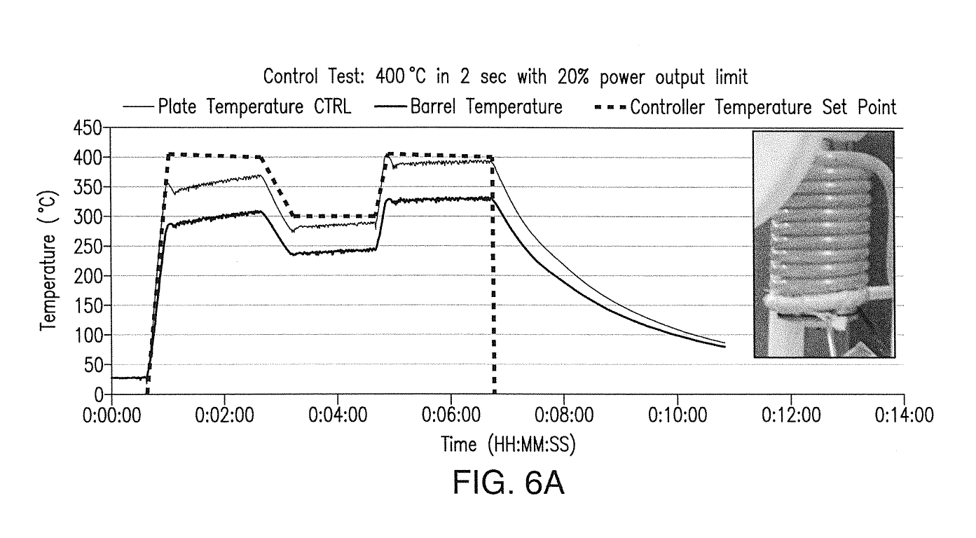

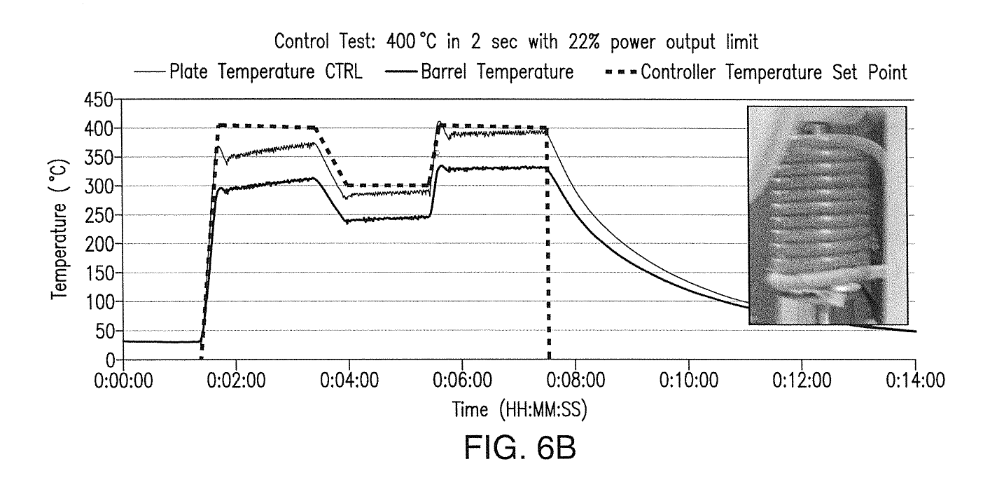

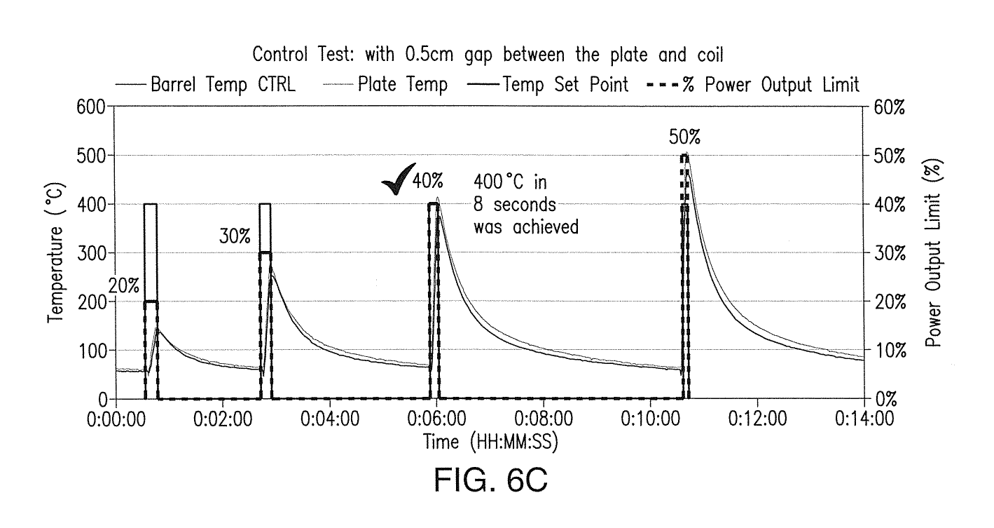

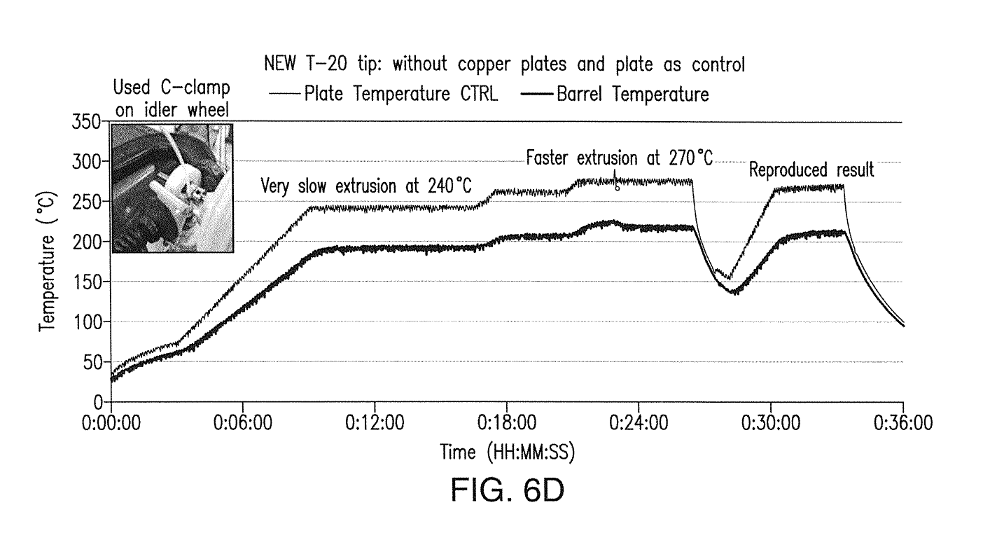

FIGS. 6A-6D demonstrate an application of the limits of this technology to additive manufacturing. Specifically, FIGS. 6A and 6B demonstrate a maximum power output limit, i.e., the threshold beyond which the plate 90 begins to melt. FIG. 6A shows the result of a control test at 400° C. in 2 seconds with a 20% power output limit which resulted in the plate 90 glowing red during heat up. FIG. 6B shows the results of a control test at 400° C. in 2 seconds with a 22% power output limit. The 22% power output resulted in the plate 90 glowing brighter. The conclusion drawn from these tests was a 20% maximum power limit to maintain the integrity of the deposition nozzle 80.

FIGS. 6C demonstrates results of a test to displace the plate 90 from the bottom winding at a distance at which the plate 90 and the barrel 85 are at thermal equilibrium to demonstrate rapid heating of the barrel 85. The results of this test demonstrate that thermal equilibrium is achieved when the plate 90 was displaced at a distance of 0.50 cm from the bottom winding of the coil 120. In such a manner, temperatures of the barrel 85 may be quickly attained and adjusted. FIG. 6D demonstrates adding power to the coil 120 positioned around the nozzle 80 to extrude plastic by controlling temperature to the plate 90 between 240° C. and 280° C.

According to a preferred embodiment of this invention, heating efficiency and energy transfer dynamics are tunable in this magneto-dynamic approach by tailoring the magnetic and/or the conductive properties of the polymer feed material. This is accomplished by compounding the polymer feed stock with specific magnetically active materials, microscale particles, nano particles, and/or carbon fiber. As a result, a portfolio of tuned polymer feed materials may be employed depending on the desired characteristics of the build.

As described, the polymeric working material is preferably tuned by matching a magnetic response of the working material to an electromagnetic wave. This is preferably accomplished by compounding or doping the working material with magnetically active microscale and/or nano particles to adjust a heating efficiency of the magnetic field. The polymeric working material preferably comprises a thermoplastic or thermosetting polymer, such as a nylon or epoxy. Suitable doping agents may include at least one of iron oxide, manganese borate, nano particles, and/or carbon fiber. Suitable nano particles may include at least one of Ho_{0.06}Fe_{2.94}O₄ and Gd_{0.06}Fe_{2.94}O₄.

According to a preferred embodiment of the invention, the polymeric working material comprises 90-99% a polymer matrix and 1-10% doping agent and more preferably 95-99% a polymer matrix and 1-5% doping agent.

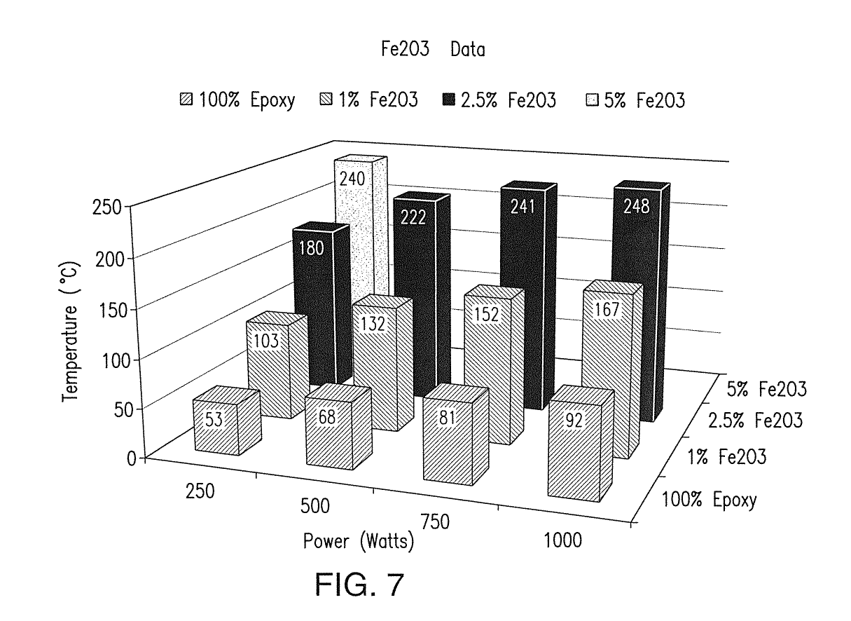

In addition, FIGS. 7-10 show the results of various tests demonstrating the effectiveness of doped polymer feed materials having iron oxide, manganese borate, nano particles, or carbon fiber.

Specifically, FIG. 7 is a graph showing data for heating a polymer matrix doped with iron oxide (Fe₂O₃) according to one embodiment of this invention. As shown, a 2.5% content of iron oxide in a polymer matrix substantially boosts attainable temperatures at various power levels of 250, 500, 750 and 1000 Watts, respectively.

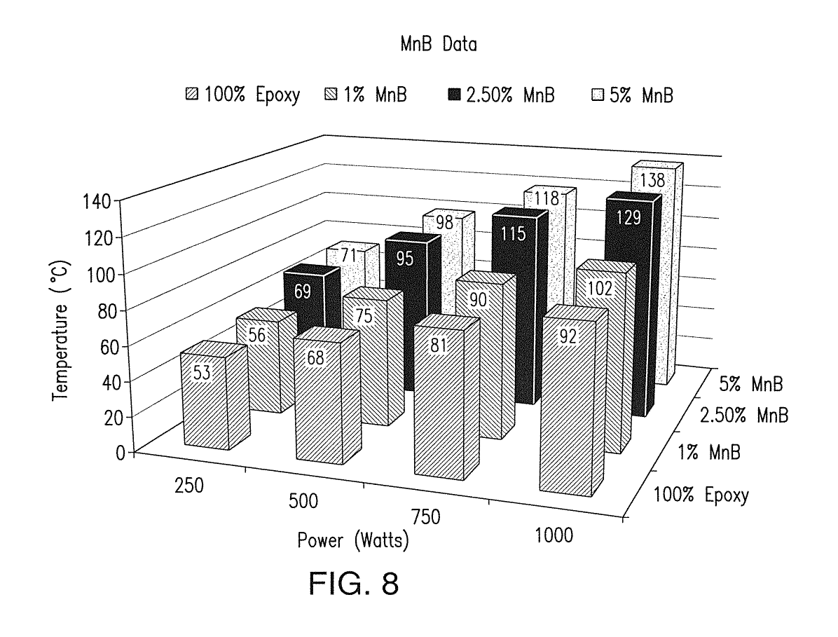

FIG. 8 is a graph showing data for heating a polymer matrix doped with manganese borate (MnB) according to one embodiment of this invention. As shown, a 2.5% but less than 5% content of manganese borate in a polymer matrix results in increased temperatures at various power levels of 250, 500, 750 and 1000 Watts, respectively.

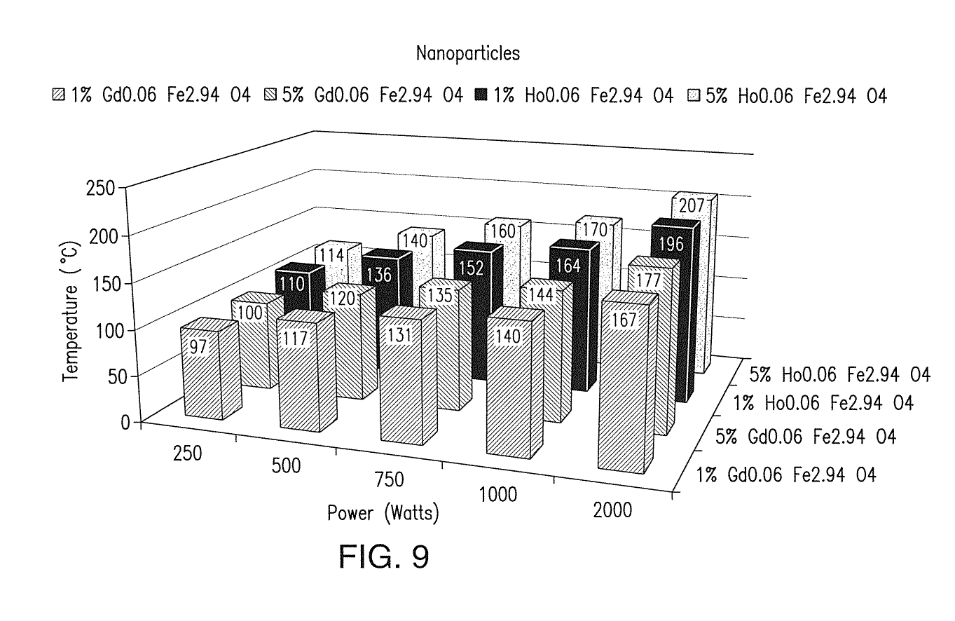

FIG. 9 is a graph showing data for heating a polymer matrix doped with nano particles according to one embodiment of this invention.

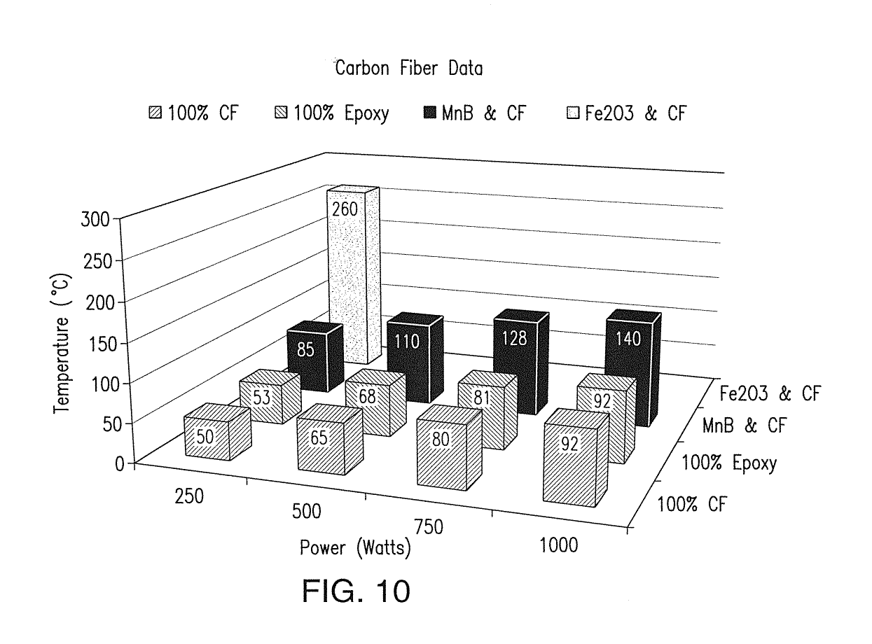

FIG. 10 is a graph showing data for heating a polymer matrix doped with carbon fiber according to one embodiment of this invention. As shown, various carbon fiber contents may result in increased temperatures at various power levels of 250, 500, 750 and 1000 Watts, respectively. Functionally, the carbon fiber preferably permits the rapid and uniform distribution of heat generated at the magnetic active centers throughout the build.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A printing nozzle for use in polymer extrusion based deposition for additive manufacturing comprising:
a material guide for permitting a desired flow of a working material;
a tip positioned at an end of the material guide for depositing the working material in an appropriate position in space; and
an electro-magnetic heating element positioned with respect to the material guide.

2. The printing nozzle of claim 1 wherein the material guide is metallic.

3. The printing nozzle of claim 1 wherein the material guide is at least one of ceramic and non-electrically conductive.

4. The printing nozzle of claim 1 wherein the electro-magnetic heating element comprises a coil positioned around the material guide.

5. The printing nozzle of claim 4 wherein the coil is arranged with non-uniform spacing.

6. The printing nozzle of claim 5 wherein the non-uniform spacing of the coil is tighter at a distal end of the nozzle.

7. The printing nozzle of claim 5 wherein the non-uniform spacing of the coil is tighter at a proximal end of the nozzle.

8. The printing nozzle of claim 5 wherein the non-uniform spacing of the coil is tighter at a center of the nozzle.

9. The printing nozzle of claim 5 wherein the non-uniform spacing of the coil is tighter at a both ends of the nozzle.

10. The printing nozzle of claim 1 wherein the electro-magnetic heating element is maintained at a lower temperature than the material guide.

11. The printing nozzle of claim 1 further comprising a heat exchanger positioned with respect to at least one of the barrel and the tip for cooling.

12. The apparatus of claim 11 wherein the heat exchanger circulates at least one of helium, air, carbon dioxide and nitrogen to cool at least one of the barrel and the tip.

13. The apparatus of claim 1 wherein the working material is doped with at least one of magnetically susceptible and electrically conductive materials to precisely control heating of the working material.

14. The apparatus of claim 1 wherein the coil is coating with an insulating material.

15. A printing nozzle for use in polymer extrusion based deposition for additive manufacturing comprising:
a metallic material guide for permitting a desired flow of a working material, wherein the working material is doped with at least one of magnetically susceptible and electrically conductive materials;
a tip positioned at an end of the material guide for depositing the working material in an appropriate position in space; and
an electro-magnetic heating coil positioned around the metallic material guide.

16. The printing nozzle of claim 15 wherein the electro-magnetic heating element is maintained at a lower temperature than the material guide.

17. The printing nozzle of claim 15 further comprising a heat exchanger positioned with respect to at least one of the barrel and the tip for cooling.

18. The printing nozzle of claim 15 further comprising a power supply coupled to the electro-magnetic heating coil.

19. The printing nozzle of claim 15 further comprising a series of electro-magnetic heating coils arranged around the metallic material guide.

20. The printing nozzle of claim 15 further comprising a gantry for providing movement through at least two axes of the printing nozzle.
